(19) United States
(12) Patent Application Publication
(10) Pub. No.: US 2023/0294789 A1
(43) Pub. Date: Sep. 21, 2023

(54) ELECTRIC MOTORBIKE HANDLEBAR GRIP ARRANGEMENT

(71) Applicant: Super73, Inc., Irvine, CA (US)

(72) Inventors: Jonathan Kikawa, Irvine, CA (US); Levi Price, Irvine, CA (US); Ian Kos, Irvine, CA (US); Karoline Rachel Davidian, Irvine, CA (US)

(21) Appl. No.: 17/695,095

(22) Filed: Mar. 15, 2022

(51) Int. Cl. B62K 23/04

(52) U.S. Cl. CPC B62K 23/04

(57) ABSTRACT

A set of handlebar grips for use with an electric motorbike is provided. The set of handlebar grips comprising a first handlebar grip having a first differentiating characteristic and a second handlebar grip having a second differentiating characteristic. The first differentiating characteristic differs from the second differentiating characteristic. One of the first handlebar grip and second handlebar grip is rotatable to power the electric motorbike.

The patent or application file contains at least one drawing executed in color. Copies of this patent or patent application publication with color drawing(s) will be provided by the Office upon request and payment of the necessary fee.

### BACKGROUND OF THE INVENTION

### Field of the Invention

The present invention relates generally to electronic motorbikes or scooters, and more particularly to handlebar grips used on such electric scooters.

### DESCRIPTION OF THE RELATED ART

Vehicles such as motorized bicycles have been around for decades. Mopeds offer an ability to pedal as well as operate the vehicle under power. Newer devices, called electric motorbikes, employ electric power in the form of a battery and can also be operated using a set of pedals.

Such devices can be simple to operate for experienced riders. However, adults who have never ridden motorbikes or motorcycles, as well as children, can be intimidated or uncertain when approaching an electric motorbike. There can be confusion as to how to operate the device, and in stressful situations, adult and youth riders can become disoriented or confused and can have challenges causing or controlling the motorbike to perform as intended. A rider may brake when he or she wants to accelerate or may not know how to control the vehicle, and such actions can be dangerous or even life threatening.

It would be desirable to offer a vehicle such as an electric motorbike that offers the uninitiated an ability to quickly recognize proper controls for a given situation and improves upon previously available designs. It would also be desirable to offer a motorbike design that is relatively easy for the uninitiated or for children to use wherein the rider can readily control the vehicle appropriately.

### SUMMARY OF THE INVENTION

According to one aspect of the present design, there is provided a set of handlebar grips for use with an electric motorbike, the set of handlebar grips comprising a first handlebar grip having a first differentiating characteristic and a second handlebar grip having a second differentiating characteristic. The first differentiating characteristic differs from the second differentiating characteristic. One of the first handlebar grip and second handlebar grip is rotatable to power the electric motorbike.

According to another aspect of the present design, there is provided a set of handlebar grips comprising a first handlebar grip having a first differentiating characteristic and a second handlebar grip having a second differentiating characteristic. The first differentiating characteristic differs from the second differentiating characteristic.

According to a further aspect of the present design, there is provided a set of handlebar grips comprising a first handlebar grip having a first differentiating attribute and a second handlebar grip having a second differentiating attribute. The first differentiating attribute differs from the second differentiating attribute.

These and other advantages of the present invention will become apparent to those skilled in the art from the following detailed description of the invention and the accompanying drawings.

### BRIEF DESCRIPTION OF THE DRAWINGS

For a more complete understanding of the present disclosure, reference is now made to the following figures, wherein like reference numbers refer to similar items throughout the figures:

FIG. 1A is a top, front, and left perspective view of an Electric Motorbike Handlebar Grip Arrangement according to the present design;

FIG. 1B is an alternate top, front, and left perspective view of an Electric Motorbike Handlebar Grip Arrangement according to the present design;

FIG. 2A is a top, rear, and left perspective view of an Electric Motorbike Handlebar Grip Arrangement according to the present design;

FIG. 2B is an alternate top, rear, and left perspective view of an Electric Motorbike Handlebar Grip Arrangement according to the present design;

FIG. 3A is a front, top, and left side perspective view of one grip, such as a right side grip of a first color, in accordance with the present design;

FIG. 3B is a rear, top, and right side perspective view of one grip, such as a right side grip of the first color, in accordance with the present design;

FIG. 4A is a front, top, and left side perspective view of a first alternate grip design, such as a right side grip, in accordance with the present design;

FIG. 4B is a rear, top, and right side perspective view of a first alternate grip design, such as a right side grip, in accordance with the present design;

FIG. 5A is a front, top, and left side perspective view of one grip, such as a right side grip, with line shading to indicate the grip is red in color, in accordance with the present design;

FIG. 5B is a rear, top, and right side perspective view of one grip, such as a right side grip, with line shading to indicate the grip is red in color, in accordance with the present design;

FIG. 6A is a front, top, and left side perspective view of one grip, such as a left side grip, having an attribute differing from a corresponding right side grip, such as a different color, shape, or tactile feel, in accordance with the present design;

FIG. 613 is a rear, top, and right side perspective view of one grip, such as a left side grip, having an attribute differing from a corresponding right side grip, such as a different color, shape, or tactile feel, in accordance with the present design;

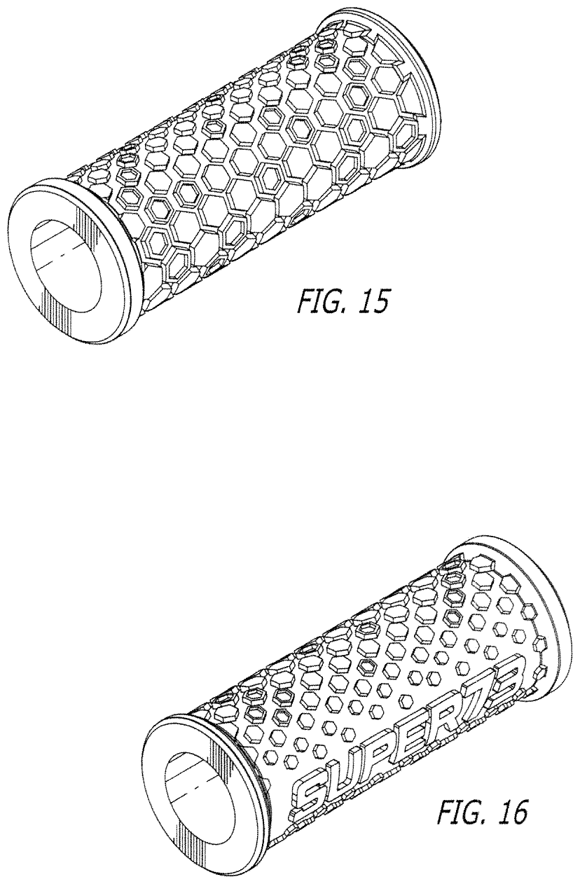

FIG. 7 is a front, top, and left side perspective view of one grip, such as a right side grip having a first attribute, of an Electric Motorbike Handlebar Grip Arrangement in accordance with the present design;

FIG. 8 is a rear, top, and right side perspective view of one grip, such as a right side grip having a first attribute, of an Electric Motorbike Handlebar Grip Arrangement in accordance with the present design;

FIG. 9 is a front elevation view of one grip, such as a right side grip having a first attribute, of an Electric Motorbike Handlebar Grip Arrangement in accordance with the present design;

FIG. 10 is a rear elevation view of one grip, such as a right side grip having a first attribute, of an Electric Motorbike Handlebar Grip Arrangement in accordance with the present design;

FIG. 11 is a top plan view of one grip, such as a right side grip having a first attribute, of an Electric Motorbike Handlebar Grip Arrangement in accordance with the present design;

FIG. 12 is a bottom plan view of one grip, such as a right side grip having a first attribute, of an Electric Motorbike Handlebar Grip Arrangement in accordance with the present design;

FIG. 13 is a left side elevation view of one grip, such as a right side grip having a first attribute, of an Electric Motorbike Handlebar Grip Arrangement in accordance with the present design;

FIG. 14 is a right side elevation view of one grip, such as a right side grip having a first attribute, of an Electric Motorbike Handlebar Grip Arrangement in accordance with the present design;

FIG. 15 is a front, top, and left side perspective view of one grip, such as a left side grip having a second attribute, of an Electric Motorbike Handlebar Grip Arrangement in accordance with the present design; and

FIG. 16 is a rear, top, and right side perspective view of one grip, such as a left side grip having a second attribute, of an Electric Motorbike Handlebar Grip Arrangement in accordance with the present design.

### DETAILED DESCRIPTION

The following description and the drawings illustrate specific embodiments sufficiently to enable those skilled in the art to practice the system and method described. Other embodiments may incorporate structural, logical, process and other changes. Examples merely typify possible variations. Individual elements and functions are generally optional unless explicitly required, and the sequence of operations may vary. Portions and features of some embodiments may be included in, or substituted for, those of others.

The present design is an electric motorbike design that visually differentiates the handle grips on typical handlebars. The design may be used with any type motorized vehicle, including but not limited to electric scooters, motorcycles, mopeds, and the like. Any type of vehicle powered using hand grips may employ the present design.

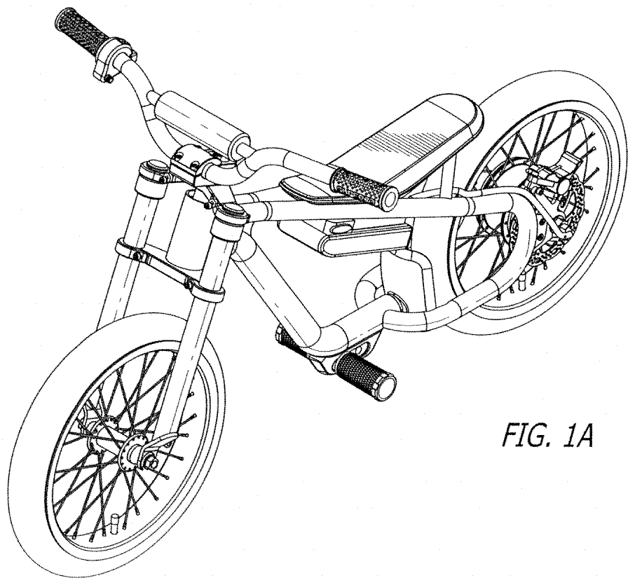

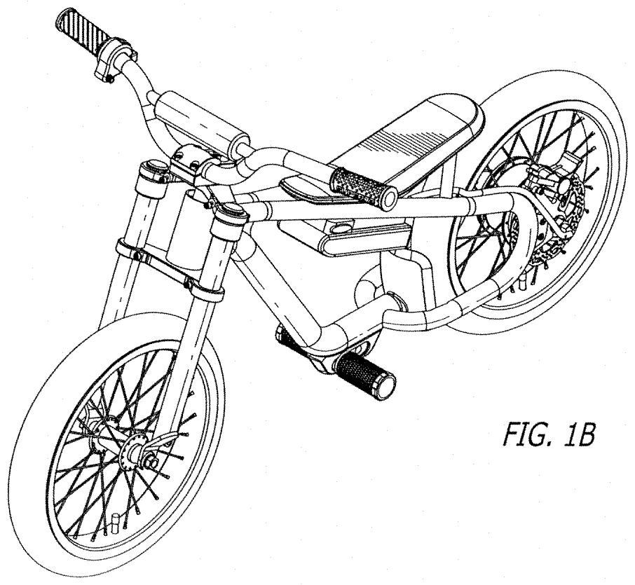

FIG. 1A is a conceptual design of a vehicle according to the present design. From FIG. 1A, there is provided an electric motorbike 101 with a battery contained in battery compartment 102. The motorbike is controlled by the user turning or rotating the right handlebar grip 103 and not turning the left handlebar grip 104, wherein the signal of the occurrence of rotation passes to a controller (not shown) and causes the battery in battery compartment 102 to provide power to a drive element (not shown) that drives rear wheel 105.

As shown in FIG. 1A, left handlebar grip 104 is of a different color or quality than right handlebar grip 103. In the FIG. 1A configuration, the right handlebar grip may be a different color, such as red, in part or in its entirety, while the left handlebar grip may be a different color, such as black. In this manner, a user can quickly determine he or she needs to turn the “red” grip to power the vehicle forward. This makes driving easier for the uninitiated and the young, offering a quick and easy way to discern what the rider should do in a given situation.

Alternate designs may be presented. For example, different colors may be used, such as green, yellow, blue, or any color that is visually distinct from the color used on the left handlebar grip 104 to an average rider. Accommodations may be made for the user, such as to accommodate color blindness if the rider or owner is color blind. Colors other than black may be used on the right handlebar grip 103 (white, blue, green, anything). In this manner, the user may simply be told or may know that he or she is to turn the “orange” handle to accelerate forward, for example.

Further, the present design may employ differentiators that are not color. For example, bumps or nubs may be provided on one handlebar grip, such as the right handlebar grip, but not the other, to provide a tactile feel for the user. However, this requires bare hands generally, and other physical indicators may be provided, such as a flat surface being cut or formed into the handlebar grip, or notches or circular or semicircular ridges, or some other physical differentiator between the left handlebar grip and the right handlebar grip. A protrusion or indentation, or multiple such physical elements, may be provided on one or the other handgrip to enable the user to differentiate the grip and employ the proper grip.

As may be appreciated, other differentiators may be provided. For example, simple circles about the periphery of the right handlebar grip, such as three red circles about the periphery, may be employed. Color may be provided over less than all of the handgrip, or some type of logo or indicating graphic may be provided. Multiple different colors may be provided. For example, a rainbow grip may be provided as opposed to a white or black opposing handgrip.

Combinations of graphic and tactile or physical differentiators may be provided that differentiate the two handgrips. For example, a different color and a different shape may be provided on the left handlebar grip and the right handlebar grip.

While shown presently with handlebar grips, the motorbike may be provided with other differentiating attributes. Such differentiating attributes may be provided with brake handles, for example, with one brake handle differing in color and/or physical quality from another, such as a blue brake handle to stop or brake the front wheel and a brown brake handle to stop or brake the rear wheel. Other colors, attributes, or arrangements, such as physical attributes, may be provided with other control components provided on electric motorbike 101.

FIG. 1B is an alternate version of the electric motorbike of FIG. 1 including lines representing the red color on the right handlebar grip.

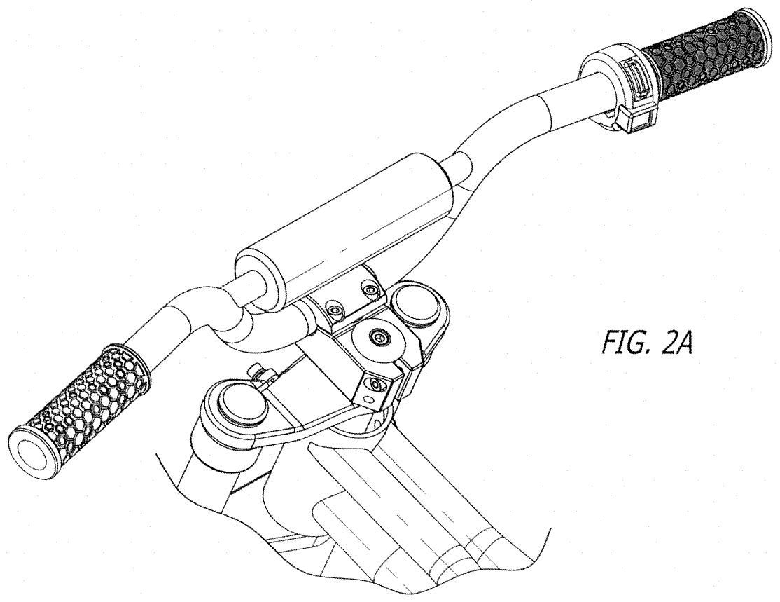

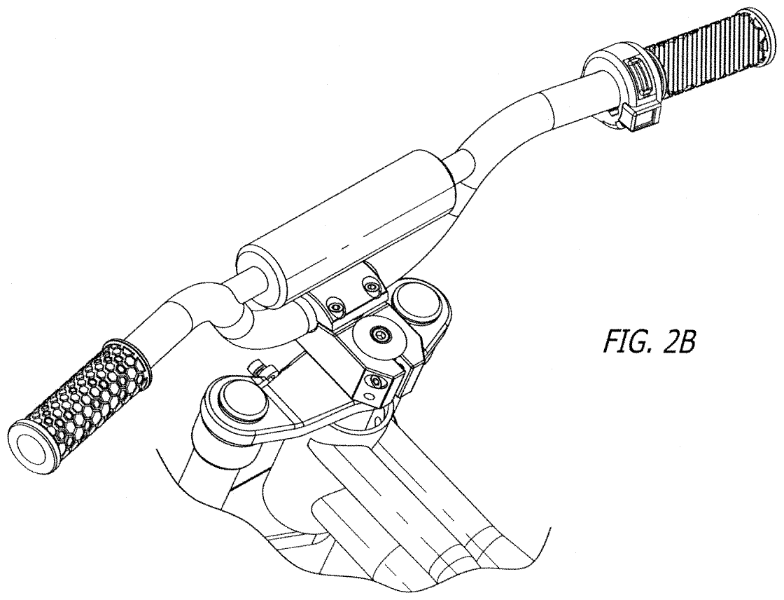

FIG. 2A illustrates a view of the handlebar grips, right handlebar grip 103 and left handlebar grip 104. In this configuration, the right handlebar grip 103 is red in color while the left handlebar grip 104 is black in color. Again, other colors, designs, or arrangements may be provided, as long as the differentiation between handlebar grips may be appreciated by certain riders, such as children. FIG. 2B is an alternate representation of the handlebar grips according to the present design including lines indicating a red color of the right handlebar grip.

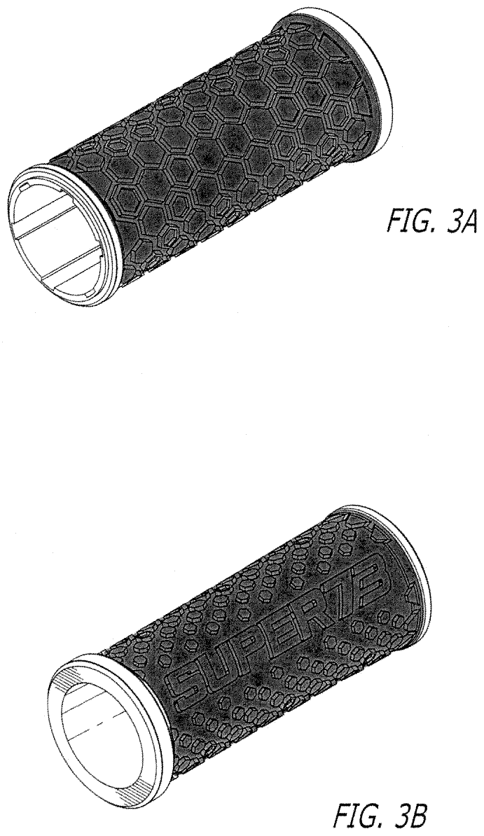

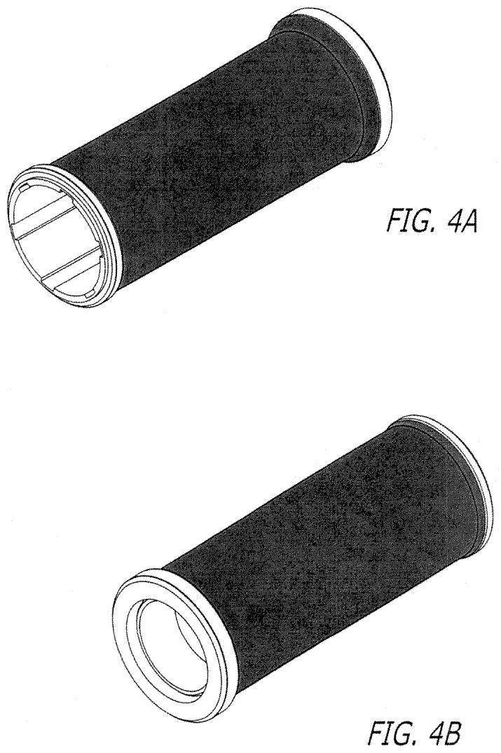

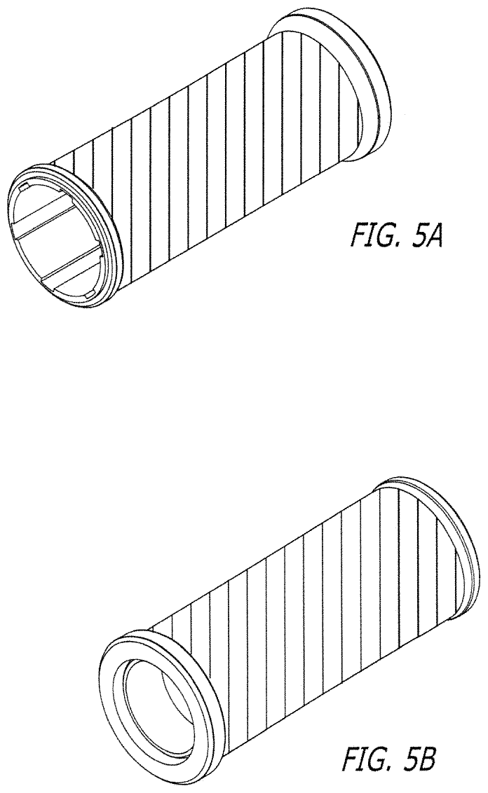

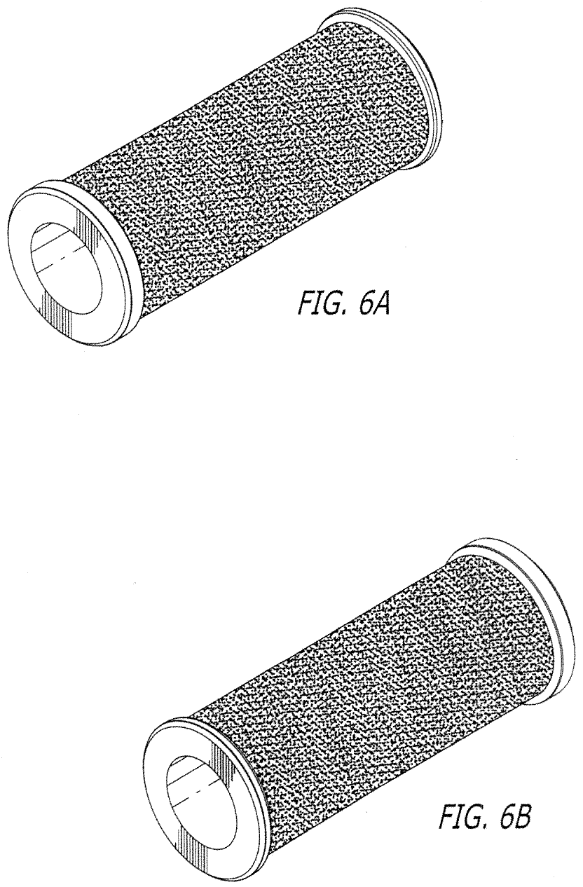

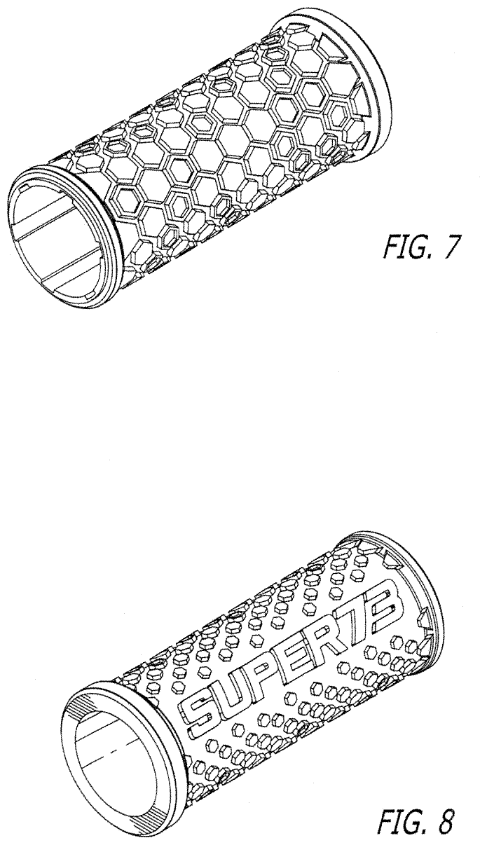

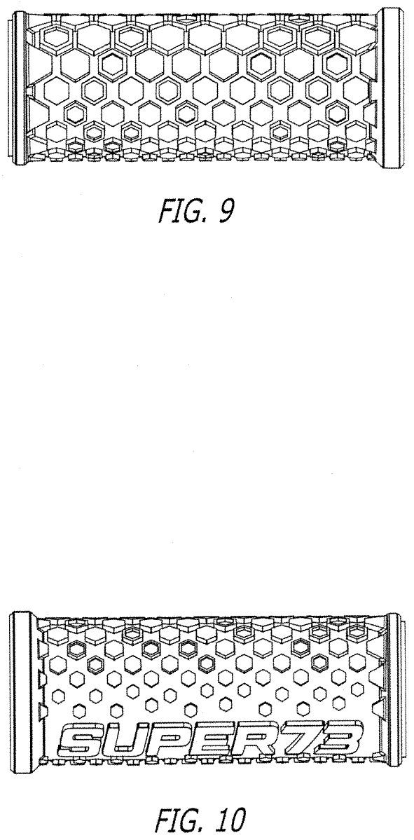

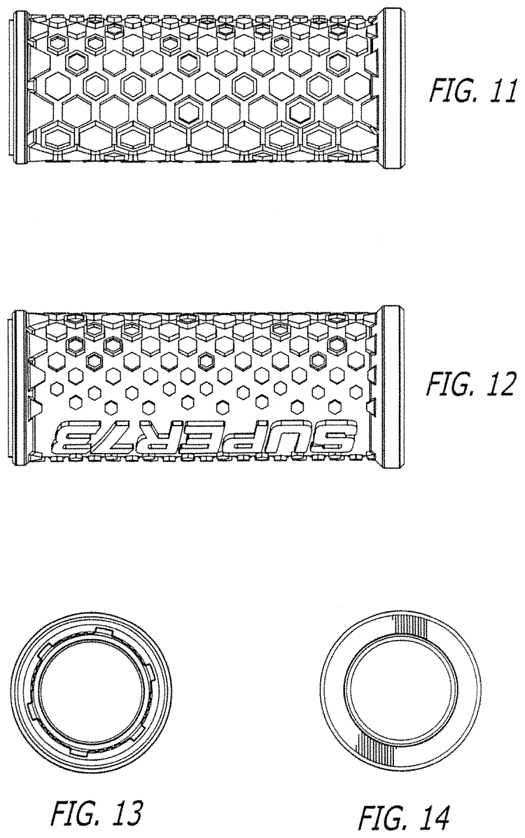

The following Figures show certain alternate design aspects of the handlebar grips. FIG. 3A is a front, top, and left side perspective view of one handlebar grip, such as a right side grip of a first color, for example red, while FIG. 3B is a rear, top, and right side perspective view of a right side handlebar grip of the first color. FIG. 4A is a front, top, and left side perspective view of a first alternate grip design, such as a right side handlebar grip. This alternate design has no elevation or raised or lowered components but is substantially smooth and in this view red in color. FIG. 4B is a rear, top, and right side perspective view of the representation of FIG. 4A. FIG. 5A is a front, top, and left side perspective view of one grip, such as a right side handlebar grip, with line shading to indicate the grip is red in color. FIG. 5B is a rear, top, and right side perspective view of one grip, such as a right side handlebar grip, with line shading to indicate the grip is red in color. FIG. 6A is a front, top, and left side perspective view of one grip, such as a left side handlebar grip, having an attribute differing from a corresponding right side grip, such as a different color, shape, or tactile feel, in accordance with the present design, and FIG. 6B is a rear, top, and right side perspective view of one grip, such as a left side handlebar grip, having an attribute differing from a corresponding right side handlebar grip, such as a different color, shape, or tactile feel.

FIG. 7 is a front, top, and left side perspective view of one grip, such as a right side handlebar grip having a first attribute, while FIG. 8 is a rear, top, and right side perspective view of one grip, such as a right side handlebar grip having a first attribute. FIG. 9 is a front elevation view of a right side handlebar grip having a first attribute, while FIG. 10 is a rear elevation view of a right side handlebar grip having the first attribute. FIG. 11 is a top plan view of a right side grip having an attribute, and FIG. 12 is a bottom plan view of a right side grip having the attribute. FIG. 13 is a left side elevation view of a right side grip having a particular attribute, while FIG. 14 is a right side elevation view of the right side grip having the particular attribute.

FIG. 15 is a front, top, and left side perspective view of one grip, such as a left side handlebar grip having a first attribute, in this case color, differing from the right side handlebar grip, may be provided. FIG. 16 is a rear, top, and right side perspective view of a left side handlebar grip having the same attribute as the grip of FIG. 15. Views in accordance with those provided or suggested herein consistent with the design provided, such as elevation views and plan views, are understood to graphically show attributes of the design as described herein.

In accordance with the present design, differentiating characteristics between handlebar grips or other motorbike components, such as control components, may be provided. Differentiating characteristics may include visual characteristics, or differences of appearance, as well as shape or tactile characteristics, but any form of differentiation recognized by an individual may be provided.

Thus according to the present design, there is provided a set of handlebar grips for use with an electric motorbike, the set of handlebar grips comprising a first handlebar grip having a first differentiating characteristic and a second handlebar grip having a second differentiating characteristic. The first differentiating characteristic differs from the second differentiating characteristic. One of the first handlebar grip and second handlebar grip is rotatable to power the electric motorbike.

According to another aspect of the present design, there is provided a set of handlebar grips comprising a first handlebar grip having a first differentiating characteristic and a second handlebar grip having a second differentiating characteristic. The first differentiating characteristic differs from the second differentiating characteristic.

According to a further aspect of the present design, there is provided a set of handlebar grips comprising a first handlebar grip having a first differentiating attribute and a second handlebar grip having a second differentiating attribute. The first differentiating attribute differs from the second differentiating attribute.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. A set of handlebar grips for use with an electric motorbike, the set of handlebar grips comprising:
a first handlebar grip having a first differentiating characteristic; and
a second handlebar grip having a second differentiating characteristic;
wherein the first differentiating characteristic differs from the second differentiating characteristic, and wherein one of the first handlebar grip and second handlebar grip is rotatable to power the electric motorbike.

2. The set of handlebar grips of claim 1, wherein the first differentiating characteristic is a first color and the second differentiating characteristic is a second color.

3. The set of handlebar grips of claim 2, wherein the first color is black and the second color is red.

4. The set of handlebar grips of claim 1, wherein the first differentiating characteristic is a first shape and the second differentiating characteristic is a second shape.

5. The set of handlebar grips of claim 4, wherein the first shape comprises a set of protrusions and the second shape comprises an absence of protrusions.

6. The set of handlebar grips of claim 1, wherein the first differentiating characteristic is a graphical indication and the second differentiating characteristic is an absence of the graphical indication.

7. The set of handlebar grips of claim 1, wherein the first differentiating characteristic visually differs from the second differentiating characteristic.

8. A set of handlebar grips, comprising:
a first handlebar grip having a first differentiating attribute; and
a second handlebar grip having a second differentiating attribute;
wherein the first differentiating attribute differs from the second differentiating attribute.

9. The set of handlebar grips of claim 8, wherein the first differentiating attribute is a first color and the second differentiating attribute is a second color.

10. The set of handlebar grips of claim 9, wherein the first color is black and the second color is red.

11. The set of handlebar grips of claim 8, wherein the first differentiating attribute is a first shape and the second differentiating attribute is a second shape.

12. The set of handlebar grips of claim 11, wherein the first shape comprises a set of protrusions and the second shape comprises an absence of protrusions.

13. The set of handlebar grips of claim 8, wherein the first differentiating characteristic is a graphical indication and the second differentiating characteristic is an absence of the graphical indication.

14. The set of handlebar grips of claim 8, wherein the first differentiating characteristic tactilely differs from the second differentiating characteristic.

15. A set of handlebar grips, comprising:
a first handlebar grip having a first differentiating characteristic; and
a second handlebar grip having a second differentiating characteristic;
wherein the first differentiating characteristic differs from the second differentiating characteristic.

16. The set of handlebar grips of claim 15, wherein the first differentiating characteristic is a first color and the second differentiating characteristic is a second color.

17. The set of handlebar grips of claim 16, wherein the first color is black and the second color is red.

18. The set of handlebar grips of claim 15, wherein the first differentiating characteristic is a first shape and the second differentiating characteristic is a second shape.

19. The set of handlebar grips of claim 18, wherein the first shape comprises a set of protrusions and the second shape comprises an absence of protrusions.

20. The set of handlebar grips of claim 15, wherein the first differentiating characteristic is a graphical indication and the second differentiating characteristic is an absence of the graphical indication.
